(19) United States
(12) Patent Application Publication
(10) Pub. No.: US 2025/0232560 A1
(43) Pub. Date: Jul. 17, 2025

(54) Self-Supervised Search Systems and Methods for Geospatial Imagery Using Iteratively Refined Representations

(71) Applicant: PERCIPIENT.AI INC., Santa Clara, CA (US)

(72) Inventors: Atul KANAUJIA, San Jose, CA (US); Vasudev PARAMESWARAN, Fremont, CA (US); Simon CHEN, Pleasanton, CA (US); Jasvinder SINGH, Newark, CA (US); Yash VYAS, Santa Clara (IN); Vidya TALAPADY, Sunnyvale, CA (US); Derek YOUNG, Boulder, CO (US); Lucas Matthias HURWITZ, Santa Cruz, CA (US); Alison HIGUERA, San Jose, CA (US); Paarth SHAH, San Jose, CA (US); Balan AYYAR, Oakton, VA (US)

(73) Assignee: PERCIPIENT.AI INC., Santa Clara, CA (US)

(21) Appl. No.: 19/023,234

(22) Filed: Jan. 15, 2025

Related U.S. Application Data
(60) Provisional application No. 63/621,136, filed on Jan. 16, 2024.

(51) Int. Cl. G06V 10/762; G06T 3/60; G06V 10/764; G06V 20/10

(52) U.S. Cl. CPC G06V 10/762; G06T 3/60; G06V 10/764; G06V 20/176; G06V 20/188; G06V 2201/07

(57) ABSTRACT

An end-to-end system and method for detecting objects of interest in geospatial imagery where the initial query comprises only an abstract of the object. A self-supervised student-teacher platform enables training an accurate model with a dataset of examples of classes of objects that may occur within geospatial imagery. Algorithms are applied to automate searching patterns in the dataset that actualize the abstract to cause the model to return images responsive to the abstract. The result may be iteratively refined so that images ultimately yielded by the search are examples of the object of interest.

### RELATED APPLICATIONS

This application is a conversion and claims the benefit of U.S. Patent Application S.N. 63/621,136 filed Jan. 16, 2024, and having the same title as the present application. Further, this application is related to U.S. patent application Ser. No. 17/866,389, filed Jul. 15, 2022 as well as U.S. patent application Ser. No. 18/936,974 filed Nov. 4, 2024, and further as well as PCT patent application PCT/US24/54026 filed Oct. 31, 2024, each of which is incorporated herein by reference.

### FIELD OF THE INVENTION

This invention relates generally to systems and methods for searching geospatial images for objects described in a query, and more particularly relates to self-supervised systems and methods for searching satellite or other geospatial video and imagery data using queries that initially describe only a limited number of invariant features.

### BACKGROUND

While humans are adept at learning to detect and recognize a new object after observing only a few images, training machines to detect objects typically uses significantly more examples. Humans can come across images of a variety of objects that are not precisely the object they are searching for, but present features that let the human more concretely identify and define the object that they are searching for until the actual object of becomes identifiable. Still, the human faces numerous limitations in performing such analysis, not the least of which is the inability to filter large sets of data rapidly which is where machines and automated systems have the advantage.

Various techniques have been developed for automated video analysis, but such object and activity detection is typically performed in a supervised setting where a deep neural network is trained to detect the object and/or activities of interest by feeding to the neural network a large quantity of labeled data, frequently images. Such a supervised training process can be practical when the set of objects and/or activities of interest is known beforehand and is relatively small. When trained on only a few example images, machines have faced significant difficulty in their ability to generalize. Training object detectors typically entails availability of at least a hundred example images of the object that the user is looking for. Open source tools such as Terrapattern can provide a set of geospatial images that can be used as example images to train detectors.

While most prior art systems rely on a quantity of example images, systems for analyzing terrestrial images have existed which rely on only a small number of images. For example, the DINO platform, such as described in “DINOv2: Learning Robust Visual Features without Supervision”, arXiv: 2304.07193v1 [cs.CV] 14 Apr. 2023, can perform such functions. Such platforms, and the algorithms they implement, have proven helpful for terrestrial images, but cannot be applied directly to geospatial video or still imagery (e.g., satellite or high-altitude drones or planes) due to the vast differences between terrestrial video and still imagery and geospatial video and still imagery. For simplicity and clarity of understanding, the term “satellite” is sometimes used herein as synonymous with “geospatial” and in those instances is to be understood as including other forms of high altitude imagery.

Among the challenges presented by geospatial imagery when compared to terrestrial imagery is that, in terrestrial imagery, scale (i.e., the size of the object in the image) can vary over a wide range and models focused on terrestrial images are trained to generate embeddings that are invariant to scale. In contrast, in geospatial imagery the scale of the object typically does not vary, such that the size of an object can be an important feature or attribute. Further, in terrestrial imagery, objects appear in a fixed orientation relative to the background. For geospatial imagery, the orientation can vary yet the representation should be invariant to orientation. An additional challenge is that the viewpoint from which objects are observed in terrestrial imagery is very different from the viewpoint from which objects are observed in geospatial imagery. Likewise, the shape and texture of the foreground and background differ significantly between terrestrial and geospatial imagery. The bottom line result is that models trained on terrestrial images are unsuitable for processing satellite imagery.

As a result, there has been a long-felt need for methods and systems that can execute a query of geospatial video or still imagery where the query specifies only an incomplete description of the object of interest and where pre-labeled images are not needed for training.

### SUMMARY OF THE INVENTION

The present invention substantially overcomes the limitations of the prior art by providing a self-supervised student-teacher platform with key differentiators, relative to the prior art, that enable training an accurate model for use with satellite imagery. In the context of the invention, a user wants the system and method of the invention to search for an object or region (hereinafter simplified as just “object”) in a geospatial image, but as a starting point has only a generalized description that includes some invariant features of the object of interest, for example some features in terms of shape or texture, but lacks sufficient detail to provide the concrete visual pattern that characterizes an example. For convenience of explanation, the aforementioned generalized description may sometimes hereinafter be referred to as an “abstract” whereas an “example” refers to a concrete visual pattern of the object sought by the search, such as a representative view or appearance of such an object. In accordance with an embodiment of the invention, the abstract is encoded into a representation in the form of a floating point vector. Examples are also encoded into a representation but, as noted above, such representations encode more detail than that for an abstract.

In an embodiment, the process of the invention particularly involves training a model particularly for assessing geospatial images, such as those from satellites, drones or similar high-altitude sources. Data is collected and curated for training the model, using any of a variety of data sources that enable the system and method of the invention to develop a wide range of classes of objects that might occur within a satellite image. Algorithmic enhancements are then performed to improve the training for computing representations or embeddings of objects found in such satellite or other geospatial imagery.

Further algorithms are then applied to automate searching for patterns in the dataset that actualize the user's abstract with the goal of causing the model to return one or more images that are responsive to that abstract. The responsive images may include one or more additional or different features that the user recognizes as useful in identifying the object sought by the search. These additional features allow refinement of the representation that began as the abstract. The refined representation can then be run on the model, hopefully yielding additional images. By iteratively refining the representation, what began as an abstract of the object can be developed until the images yielded by the search are an example of the sought-after object.

It is therefore one object of the present invention to provide an end-to-end system and method that can detect objects in satellite imagery where the initial representation comprises only an abstract of the object.

It is another object of the present invention to provide data collection and curation optimized for identification of objects in satellite imagery.

It is a further object of the present invention to provide algorithmic enhancements for computing representations on satellite imagery.

A still further object of the present invention is to provide algorithmic enhancements for identifying patterns that actualize the features comprising the abstract as a way of more quickly identifying an example of the object.

Yet a further object of the present invention is to provide a framework for gathering additional images that can searched for patterns of interest where such additional images can be included in a search result based on holistic appearance similarity or by assigning different weights to shape, texture or other attributes of appearance.

Another object of the present invention is to provide a system and method for labeling repetitive patterns or objects in a satellite image.

A still further object of the present invention is to provide a system and method for continuous learning of the distribution of representations of key patches observed at the same location over successive time steps.

These and other objects of the invention can be more fully appreciated from the following detailed description of the invention, taken in combination with the appended Figures.

### FIGURES

FIG. 1 illustrates an embodiment of a process for data collection, curation and model training in accordance with the invention.

FIGS. 2A-2C are geospatial images with an object of a known class centered in the image.

FIGS. 2D-2F are large geotiffs in which a plurality of objects belonging to known classes of objects are captured.

FIGS. 3A-3C shows the result to using a generic object detector to develop object proposals for extracting training data from unlabeled geospatial data sources in accordance with an aspect of the invention.

FIGS. 4A-4B shows the result of developing a diverse set of objects from unlabeled geospatial data through the use of post-processing and selection based on objectness score in accordance with an embodiment of the invention.

FIGS. 5A-5F show open source unlabeled images of vegetation and ground patterns that are distinctive compared to textureless image regions, where FIGS. 5A-5C show crop fields and 5D-5F show ground patterns resulting from man-made structures.

FIGS. 6A-6C show the results of filtering the textured regions to identify a dominant pattern for inclusion in a training set in accordance with an embodiment of the invention.

FIG. 7A [Prior Art] shows self-supervised learning using contrastive loss.

FIG. 7B shows self-supervised learning using only positive pairs in accordance with an embodiment of the invention.

FIG. 8 shows a training flow diagram for a self-supervised teacher-student model in accordance with an embodiment of the invention.

FIG. 9 illustrates a self-distillation training algorithm in accordance with an embodiment of the invention that includes image rotation.

FIG. 10 illustrates a self-distillation training algorithm in accordance with an embodiment of the invention that includes cluster membership.

FIGS. 11A-11C show examples of searching a vertical line, FIG. 11A, where FIG. 11B shows the result of lines in different orientations and FIG. 11C shows the search results for patterns of lines in accordance with an embodiment of the invention.

FIG. 12 shows the use of metric models to transform embeddings based on selected image attributes in accordance with an embodiment of the invention.

FIG. 13 shows a process for refining the abstract query in accordance with an embodiment of an aspect of the invention.

FIG. 14 illustrates the progression that results from the refinement process of FIG. 13, where the search result migrates from the user's abstract to an example.

FIG. 15A shows the result of a user refining a query where the user selects a query patch in accordance with an embodiment of the invention.

FIG. 15B shows thumbnails resulting from running the search query against the database.

FIG. 15C shows the image corresponding to the selected thumbnail.

FIGS. 16A-16C show the more accurate results achieved by running the refined query against the model in accordance with an embodiment of the invention.

FIGS. 17A-17C shows the improvement achieved with a still further improved query, in accordance with the invention.

FIGS. 18A-18C illustrate the use of the framework of the present invention to expedite labeling of repetitive structures found in the imagery.

### DETAILED DESCRIPTION OF THE INVENTION

As noted above, the present invention permits a user to search for an object within a database of geospatial images where the user initially has a less-than-fully developed sense of what the object looks like. In such a search, that abstract of the object may include only the user's initial sense of shape, or texture, holistic appearance, or other invariant characteristics.

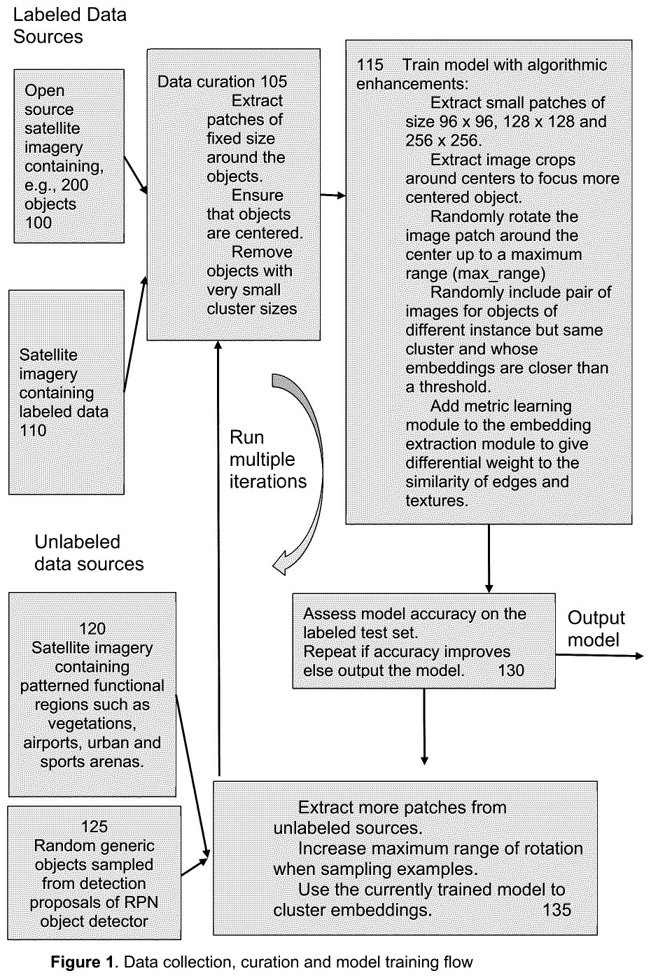

For such a search to be successful, in a presently preferred embodiment a dataset of geospatial images is carefully collected and curated to enable training of a machine learned model. The machine learned model can, in at least some embodiments, be a self-supervised teacher-student platform. With reference to FIG. 1, an embodiment of a process for training such representation models involves developing a collection of classes of objects, for example 200 classes although the number for a given implementation can be larger or smaller depending on the nature and level of detail of the geospatial images. In such an embodiment, the training process for each such class of objects involves sampling a pair of views of the same object or at least a similar object, and training two models to bring their output closer to each other.

In a system and process in accordance with the invention, the trained model is used to extract a fixed dimensional representation, or embedding, of a fixed size image patch. For example, the fixed size can be 96×96 pixels, 128×128 pixels, 256×256 pixels, or any other convenient size that is computationally reasonable. It will be appreciated that such systems typically comprise a CPU or GPU capable of exchanging data with associated random access memory as well as a mass storage device. The mass storage device can be either solid state or rotating disk. The system typically also includes I/O devices both to permit user input of a query and to display to a user the results of a search, and may include other sensors, other I/O devices, and other forms of communication devices.

The representation encodes the semantic attributes of the contents of the image patch, such as shape, texture, color, or other characteristics of an object in the image patch. A plurality of such embeddings can be developed to form a database of pre-computed patches on a regularly spaced grid of locations on a satellite image. When sufficient classes of objects have been encoded into embeddings, a representation extracted from the user's abstract can be searched against such a database as will be discussed in greater detail hereinafter.

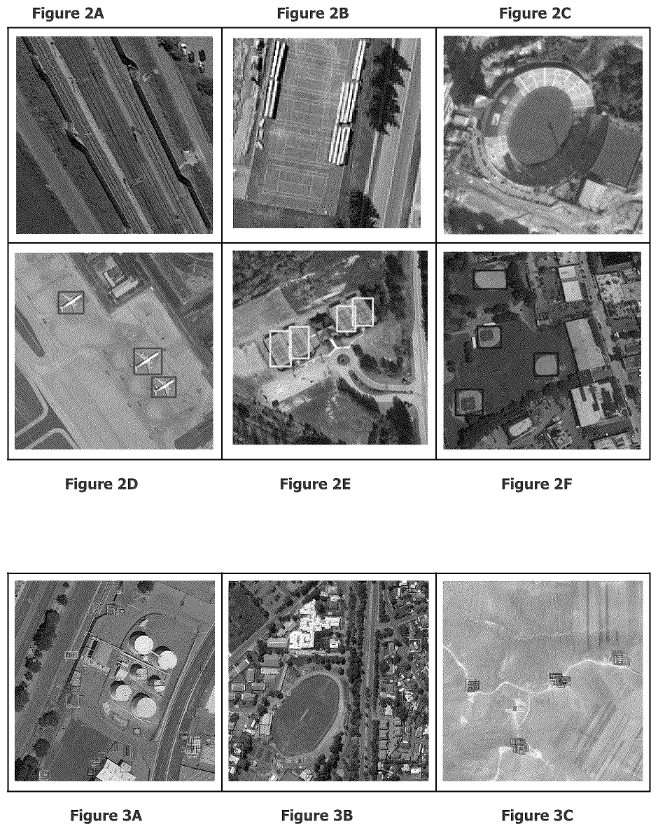

Thus, still with reference to FIG. 1, labeled satellite imagery 100, which may for example be available as open source and containing a diverse array of objects, is provided to a data curation step 105, along with additional satellite imagery containing labeled data as shown at 110. The images can be large geotiffs such as shown in FIGS. 2A-2F where the objects belong to known classes of objects such as vehicles of various types, solar panels, etc. Bounding boxes 205, 210, 215 surround the detected objects in FIG. 2D, as with bounding boxes 220, 225, 230 and 235 for FIG. 2E, and bounding boxes 240, 245, 250 and 255 for FIG. 2F.

Data curation step 105 extracts patches of fixed size (as above) around the objects, and ensures that the objects are centered within the associated patch. For example, in an embodiment, a first set of images is cropped into 128×128 patches in a small region around the center of the image and those patches are used in the training set. For a second set of images, 128×128 patches are extracted about the objects in those images, and those patches are used in the training set. Objects with very small cluster sizes are removed. For each of the image patches, the object class is preserved in order to be utilized in later iterations of training. In a presently preferred embodiment, about 200 classes of objects are accumulated from labeled sources, but the number of classes can vary widely depending upon the nature of the query as well as the nature and level of detail of the geospatial images.

In an embodiment, the output of data curation step 105 is provided to training step 115, where the model is trained with algorithmic enhancements appropriate for geospatial imagery as explained in greater detail hereinafter. The training step 115 can be briefly summarized as extracting small patches, for example in sizes 96×96, 128×128, 256×256, or any other size that is computationally efficient. Image crops are then extracted, where the crops are positioned around object centers to facilitate focusing on a more centered object. To accommodate the variety of object orientations that can occur in satellite or other geospatial imagery, image patches are randomly rotated around the center up to a maximum range to create a second image. Further, in some embodiments a pair of images for objects of a different instance but the same cluster, and whose embeddings are closer than a threshold, are randomly included in the training set. Further, in at least some embodiments, metric learning is used in the embedding extraction step to give differential weight to the similarity of edges, textures, colors, and/or other attributes.

In an embodiment, an important aspect of the training process is to gather from unlabeled data sources examples of generic objects in order to capture their objectness attributes. These unlabeled data sources can comprise satellite imagery as shown in FIG. 1 at 120 as well as random generic objects as indicated at 125 and explained in more detail in connection with FIGS. 3A-3C.

Still with reference to FIG. 1, the output of step 115 is provided to step 130, where the accuracy of the model is assessed against the labeled test set. The model is provided as an output unless additional iterations show improved accuracy. If iteration is automatically selected, the output of step 130 is provided to step 135, where more patches from unlabeled sources are extracted, the maximum range of rotation of the image patches is increased, and the currently trained model is used to cluster embeddings. The patches from unlabeled sources are provided from satellite imagery 120 and the random generic objects sampled from the RPM object detector shown at 125. The output of step 135 is fed back to data curation step 105. In a typical embodiment, the process will iterate a number of times with each iteration to yield the output model. The output model can be provided, for example, as an input to the inventions described in U.S. patent application Ser. No. 17/866,389, filed Jul. 15, 2022 as well as U.S. patent application Ser. No. 18/936,974, filed Nov. 4, 2024, both incorporated herein by reference.

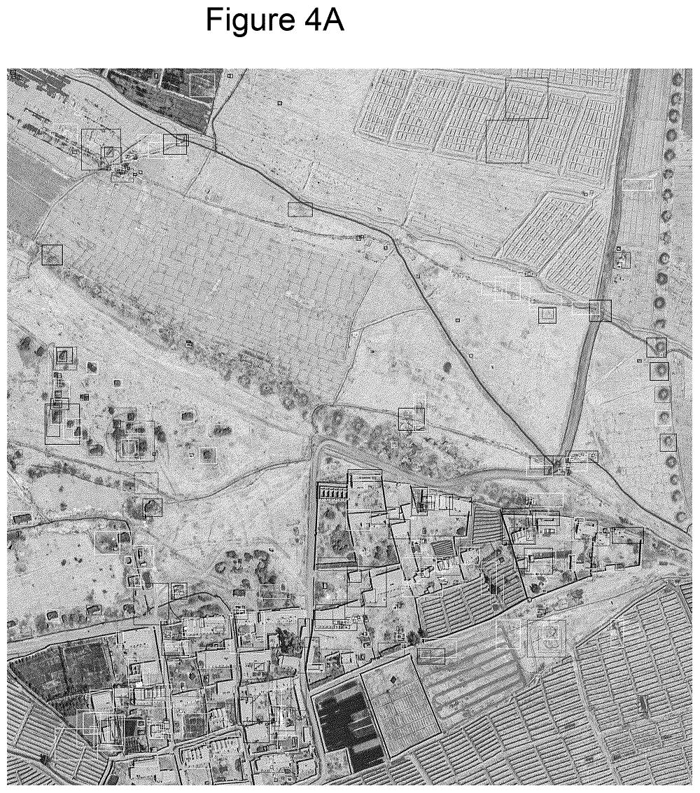

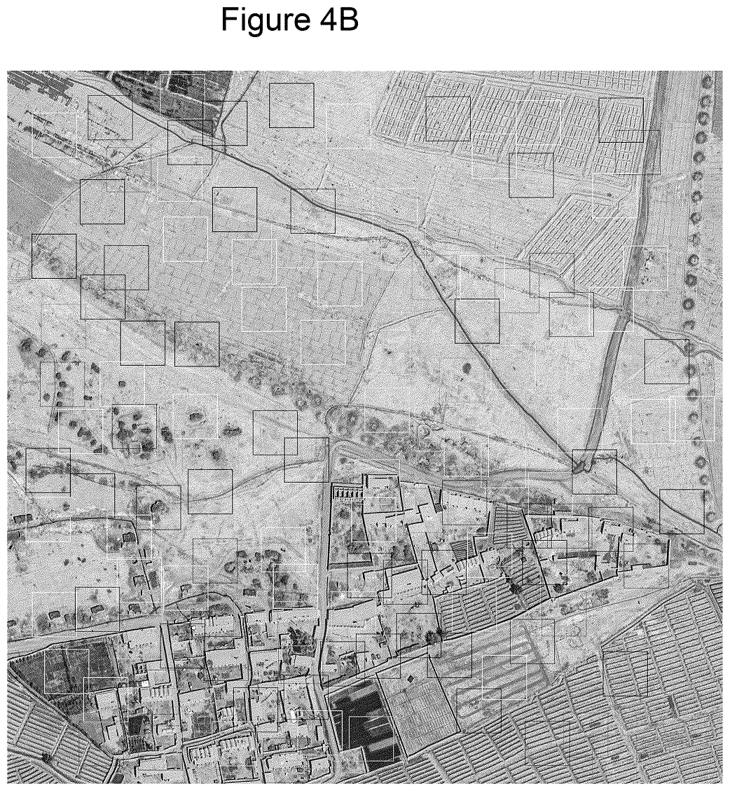

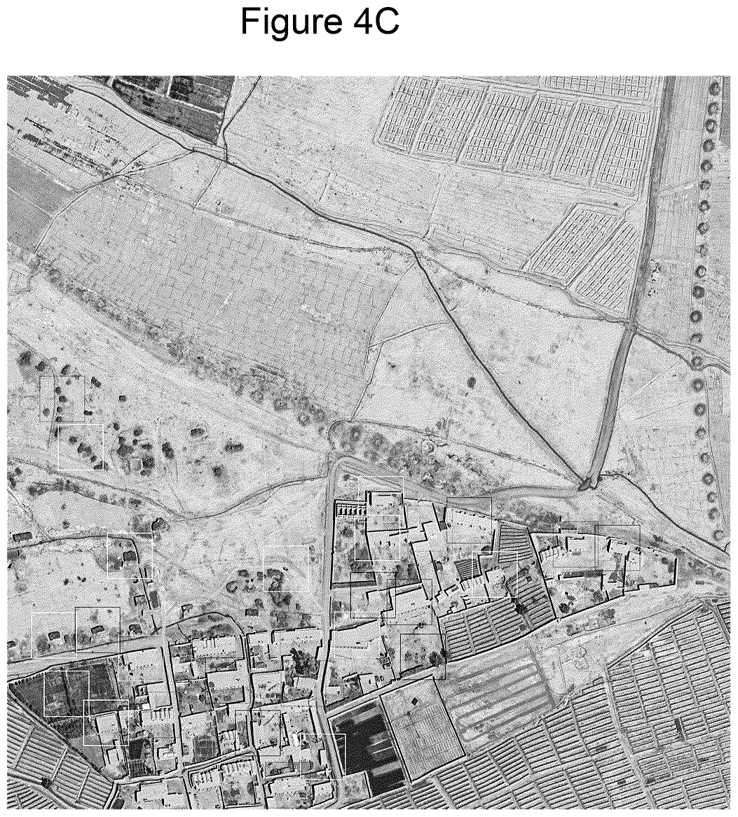

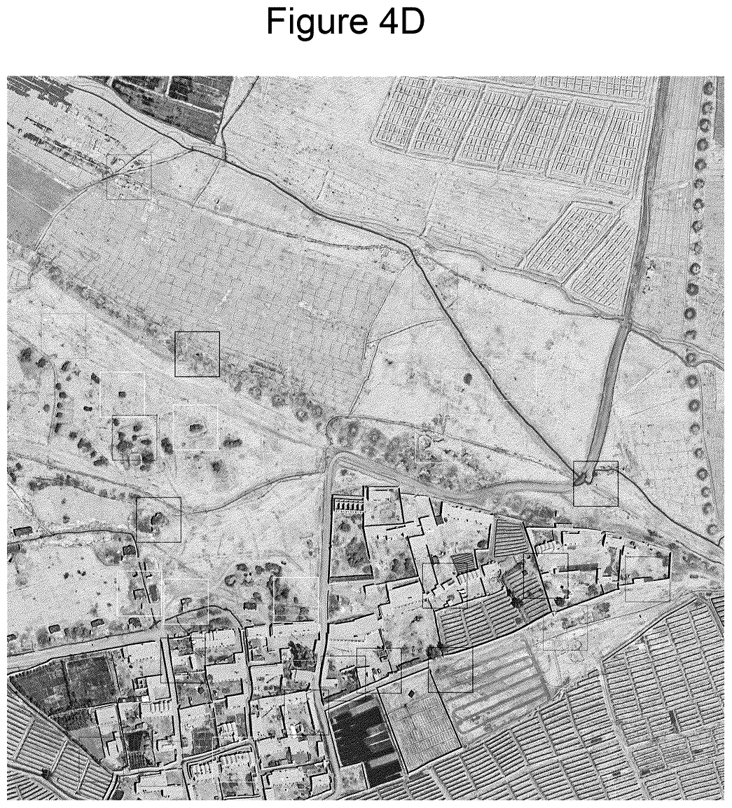

Objectness indicates the probability of an object existing within an image, and thus allows for the pruning of proposed regions of interest that do not contain any objects. It will be appreciated by those skilled in the art that the above-described process for accumulating a quantity of classes of objects, see step 105, does not provide generic objectness features that are useful for training a good representation model. To provide such objectness values, a generic object detector is used to generate proposals of objects in a satellite image. These data sources are considered unlabeled because the objects in them can belong to any class. In a presently preferred embodiment, a detector based on a region proposal network, or RPN, is used to detect generic objects in the images. FIGS. 3A-3C show examples of object proposals used for extracting training data from unlabeled data sources. For training, fixed size image patches with bounding boxes are extracted about the detected object centers. Each object detection has associated therewith an objectness score that provides a confidence metric for how likely the bounding box contains an object. In some instances, such as shown in FIG. 3C, the bounding boxes are repetitive and clustered around small regions. To sample a diverse set of objects, in an embodiment a series of post-processing steps can be implemented including, for example, sorting the detections based on objectness score, creating bounding boxes of fixed size around the detections, and running Non-Maxima Suppression (“NMS”) with a very low overlap threshold. The low overlap threshold excludes many, if not most, of the overlapping boxes, as is well understood in the art. These steps can yield a very diverse range of objects well-suited for training representations, as shown in FIGS. 4A-4D where FIG. 4A shows bounding boxes indicating the results of the generic object detector for extracting patches. FIG. 4B shows the result of applying the above-discussed post-processing to the array of bounding boxes shown in FIG. 4A, with the result that many of the overlapping boxes in FIG. 4A have been removed and more diverse objects identified. FIGS. 4C and 4D show two groups of bounding boxes, arranged according to objectness scores although any of the numerous sorting criteria known to those skilled in the art would be acceptable in at least some embodiments. For the illustrated example, FIG. 4C shows bounding boxes indicating a first group of samples with the highest objectness scores (in this example, thirty samples) and FIG. 4D shows a second group of samples with the next highest objectness scores (for this example, another thirty samples). The number of samples in a group can vary widely depending upon the specific implementation. Different classes of objects are indicated by different colors or line patterns, but can also be indicated by any other suitable indicia.

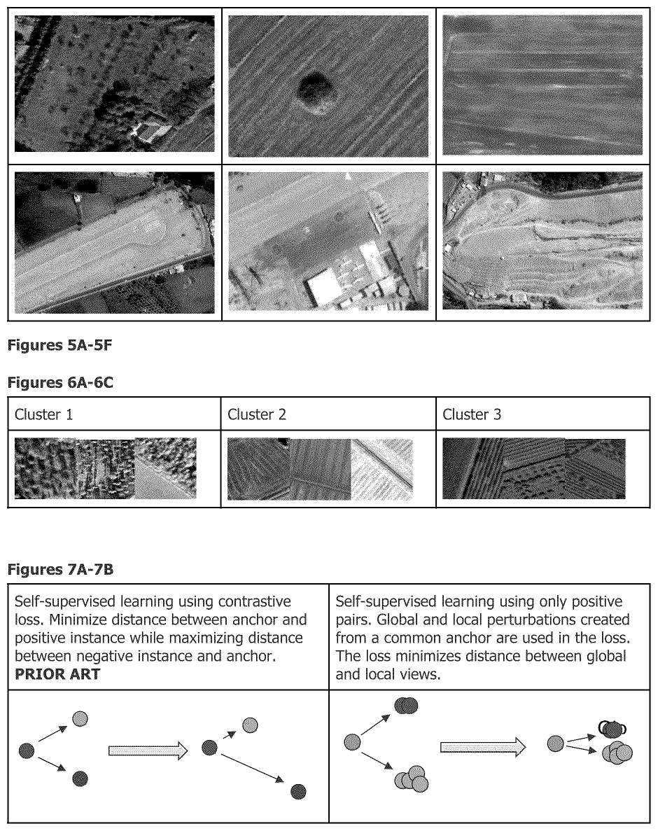

Referring next to FIGS. 5A-5F, geospatial images also can include large amounts of vegetation as well as other man-made ground patterns such as those made by structures, and training of the model needs to take these features into account. These regions are important for training purposes since one goal of learning effective representations is not only to extract object attributes but also to search patterns on the ground. To prepare the images of vegetation and ground patterns for use in training, in an embodiment of the invention random patches of a given size, for example 128×128, are extracted from the textured regions and included in the training set. However, this unlabeled information is missing the class of the different patches. Because the patches could be sampled from adjacent regions of a dominant class, and may be different categories, in such an embodiment a post-processing step is used to filter noisy patches and retain only salient patches that have a consistent and dominant pattern. In an embodiment, the following post-processing steps have proven effective: (1) train a stage-1 representation model from labeled data sources; (2) use the stage-1 model to extract vector representations of the patches from unlabeled data sources; (3) cluster the vectors using a standard K-mean clustering algorithm; (4) order the clusters by decreasing cluster sizes and eliminate the bottom-most clusters as noise. The algorithm used for clustering can be any of a generic class of clustering algorithms that do not require a predetermined number of clusters. More specifically, the required parameter is the neighborhood size, or threshold, that can be varied based on the representations extracted from the pretrained model which was trained in the previous iteration. The class of clustering algorithms can include, for example, affinity propagation, mean shift, ward hierarchical clustering, agglomerative clustering, and DBSCAN. In an embodiment, initially clusters of size N less than 10 are removed as too noisy because the representations initially used for clustering are inaccurate. As the representations used for clustering become more accurate, i.e., with more iterations, N can be reduced. The remaining cluster information is then used to train more generic representations that can learn embeddings that are invariant to intra-cluster variations. Examples of clusters in accordance with such an embodiment can be seen in FIGS. 6A-6C.

In at least some embodiments of the invention, model training is based on self-supervised learning, which involves methods that learn representations by training on pretext tasks. Pretext tasks generate self-supervised labels by hiding some spatial information about an object. In at least some embodiments, it is important the representations learned from the pretext tasks are invariant to image transformations that are considered nuisance factors. Examples of pretext tasks include predicting the relative position of a patch, rotation, gray scale to colorization, image completion from random patches, and so on. The aim of training the models to optimize the pretext tasks is for the model to learn representations from a vast set of unlabeled images without the need for explicit labels of objects or patterns. In at least some embodiments, discriminative loss, contrastive loss, or generative loss can be used to learn such representations. However, the introduction of even a small uncurated dataset can have a significant effect on the quality of the features, which makes it desirable, in at least some embodiments, to have some level of curation and a large, diverse dataset for training such self-supervised models.

In an embodiment of the present invention, training is an enhancement of the DINO framework, where the enhancements extend and adapt the training for satellite and other geospatial imagery. Pretext task optimization in a self-supervised framework training is performed in at least some prior art implementations by generating image pairs from a single instance by perturbing the image. Positive and negative pairs can be obtained from two different objects in the same image but known to be different objects. However, in the present invention, only a batch of positive pairs of instances is used for training, again where the positive pair is generated from a single instance. The use of positive pairs only provides advantages while gathering data for training because it allows clustering of the data without needing to split a class of images into multiple clusters. FIGS. 7A [Prior Art] and 7B illustrate a comparison of the loss functions used in typical self-supervised learning (FIG. 7A) versus the loss function used in the present invention (FIG. 7B).

In an embodiment, the training loss is based on generic self-supervised training using self-distillation. In one such embodiment, the generic training is performed using self-distillation wherein a teacher model and a student model with exactly the same architecture are trained in tandem. Alternative approaches include prediction of masked image token representations, direct minimization of contrastive loss using gradient-based methods, contrastive loss minimization using cluster assignment, and non-parametric classification.

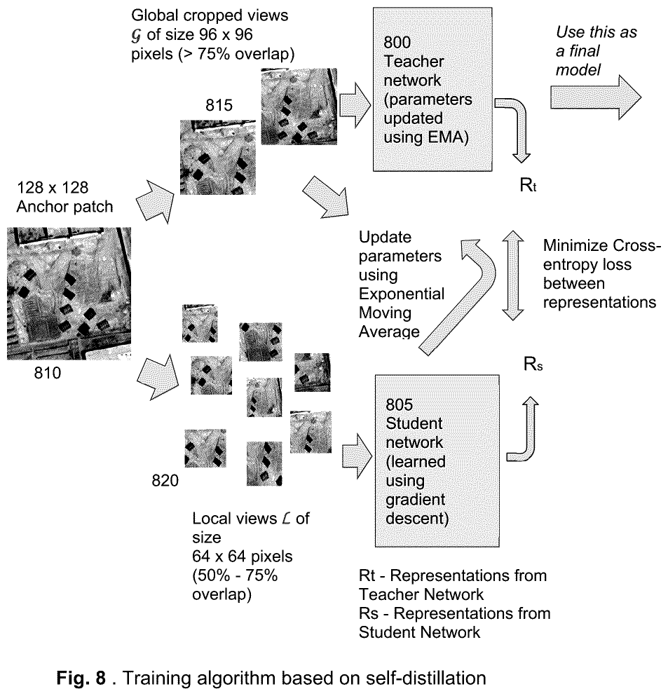

Referring next to FIG. 8, which illustrates in flow diagram form the teacher-student model training process for an embodiment of the invention. Both teacher 800 and student 805 are presented with different cropped views of the same image 810. The teacher processes the global views [symbol] indicated at 815 and generates a fixed sized representation Rₜ for each of the two global views. The student 805 processes the crops indicated at 820 in both local views [symbol] and global views [symbol] to generate representations Rₛ. Note that irrespective of size of crops, the output is a fixed dimensional representation that can be compared between each of the pairs of views of different sizes. The training minimizes the discriminative cross entropy loss between the teacher distributions and student distributions as:

min_{θ}_{ₛ} [symbol] [symbol] H(Rₜ,Rₛ)

where His the cross entropy loss for each pair of views.

For each image in the batch, sets [symbol] and [symbol] are generated. Training is achieved using gradient-based optimization of the loss function, with the parameters updated for each batch of images sampled from the training set. The gradient steps to minimize the above loss are only used to update the parameters of the student network. The teacher network is updated using Exponential Moving Average (EMA) using the corresponding weights of the student network since both student and teacher have the exact same architecture. This is a regularization algorithm to prevent weight collapse (i.e. all weights outputting single fixed representation) during the training.

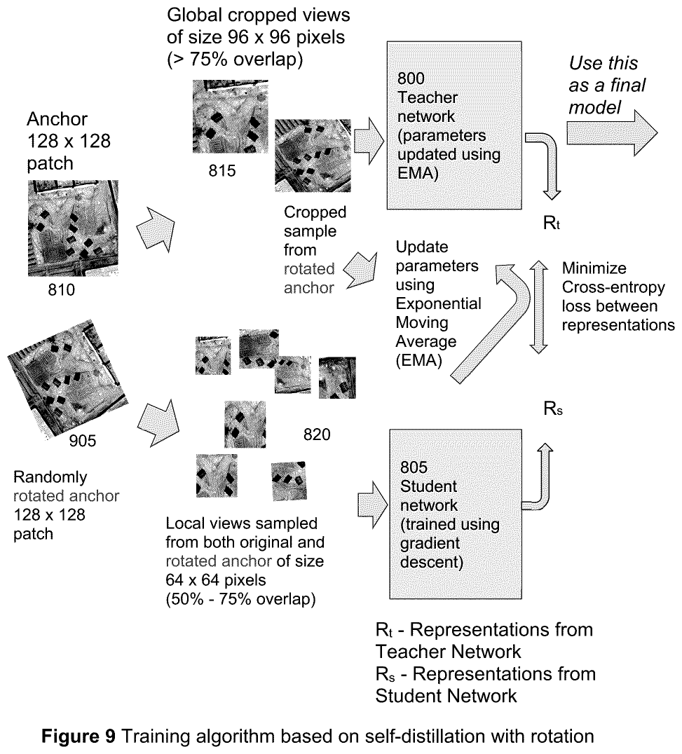

FIG. 9 illustrates the training process where image rotation is introduced to enhance the baseline training of FIG. 8 (with like numerals indicating like elements) to support geospatial imagery where the representations need to be invariant to rotation of the objects in the image:

$${min}_{{θ}_{s}} λ ( {\sum }_{t {ϵ𝒢}_{R}} {\sum }_{s ϵ \{ {𝒢}_{R} , {ℒ}_{R} \}} H ( {R}_{t} , {R}_{s} ) ) + ( 1 - λ ) ( {\sum }_{t ϵ𝒢} {\sum }_{s ϵ \{ 𝒢 , ℒ \}} H ( {R}_{t} , {R}_{s} ) )$$

where H is the cross entropy loss for each pair of views and [symbol] _{R}, [symbol] _{R} are a global view set and a local view set obtained by cropping only some of the samples from the randomly rotated anchor image 905. In at least some embodiments, the global views have a mix of rotated and original image crops. The process of generating crops is as follows. The global view crop is randomly select (with confidence A) and rotated by a random angle (up to max_range) and that rotated crop is used as a second view. Typical samplings of global views are from the same image but cropped at different locations. For rotations, the crop is the same but that same view is rotated. This reduces the range of perturbation and assists in better training. The fifty percent of the local views are cropped from the rotated image if the second global view is rotated. If not, all the local views are sampled from the original unrotated image.

In the above, A denotes the fraction of times the global views are rotated in a minibatch. When a global view crop is sampled from the rotated anchor image, the corresponding local views from the rotated anchor image are also sampled. Following figure depicts the updated training pipeline. The fraction 0<λ<1 ensures that adding rotation perturbation in addition to cropping does not create vastly different views of the anchor image thereby destabilizing the training. In successive iterations, a gradual increase in the rotation angle max_range is allowed when randomly rotating the anchor images. The final training iteration has max_range=360

In an embodiment, in order to improve further generalization of the representations learned by the model, the set of images that can be used as anchors for cropping the global and local views is expanded. Specifically, positive samples of images from the same cluster can be used as opposed to a single image. The loss function is thus the sum of multiple terms:

$${min}_{{θ}_{s}} {λ}_{1} ( {\sum }_{t {ϵ𝒢}_{C}} {\sum }_{s ϵ \{ {𝒢}_{C} , {ℒ}_{C} \}} H ( {R}_{t} , {R}_{s} ) ) + {λ}_{2} ( {\sum }_{t {ϵ𝒢}_{R}} {\sum }_{s ϵ \{ {𝒢}_{R} , ℒ \}} H ( {R}_{t} , {R}_{s} ) ) + ( 1 - ( {λ}_{1} + {λ}_{2} ) ) ( {\sum }_{t ϵ𝒢} {\sum }_{s ϵ \{ 𝒢 , ℒ \}} H ( {R}_{t} , {R}_{s} ) )$$

where 0<λ₁<λ₂<1

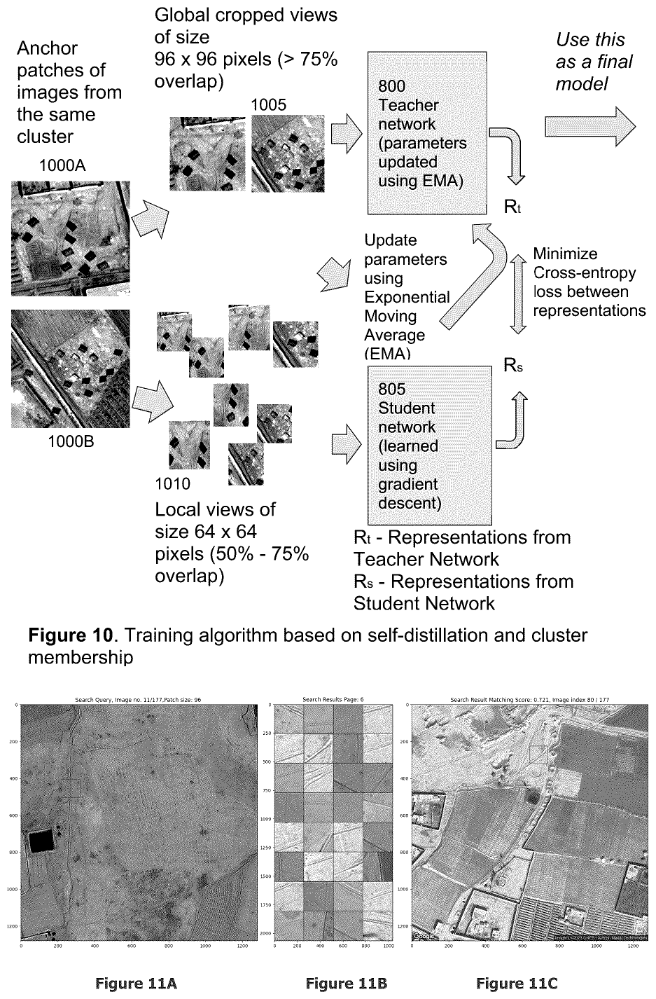

Here [symbol] _{C}, [symbol] _{C} denote the view sets obtained by cropping global and local views respectively from multiple anchor images belonging to the same cluster. The training flow is depicted in the FIG. 10, which illustrates a training algorithm in accordance with the invention that is based on self-distillation and cluster membership. Anchor patches 1000A-1000B are separated into global and local views 1005 and 1010 and provided to the teacher and student networks, respectively, as with the prior training flows. In the framework of at least some embodiments of the invention, it is therefore preferred to have clusters that belong to the same object class or semantic category. FIGS. 11A-11C illustrate implementation of an embodiment of the framework, with the example of searching a vertical line as shown in FIG. 11A, on the left, and the pattern of lines in FIG. 11C as the search results. While the highest confidence results are lines with the same orientation, the matching score of lines in different orientations (shown in the middle FIG. 11B) are comparable.

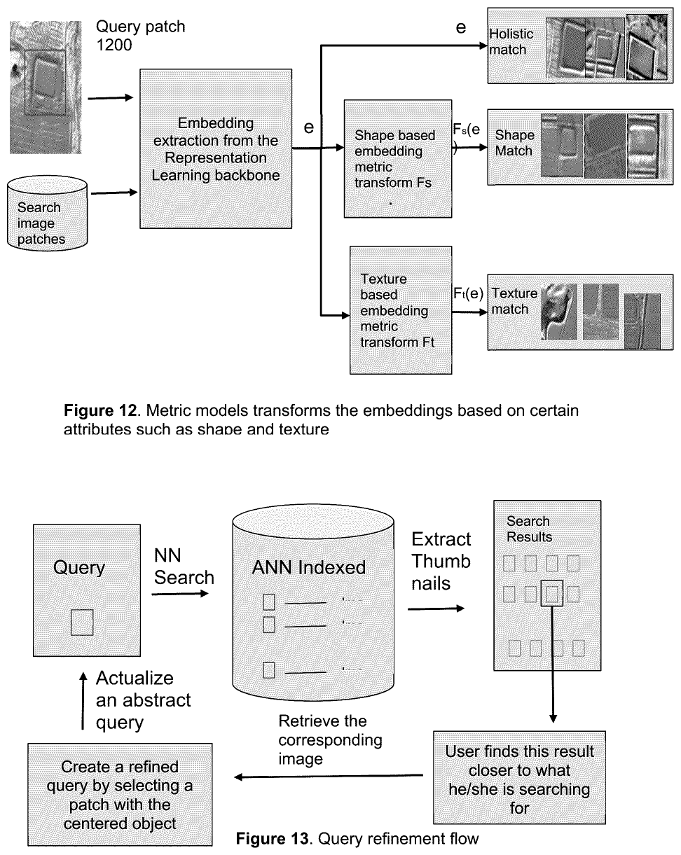

In some embodiments of the invention, metric learning can be used for matching embeddings based on attributes. As discussed herein, an important feature of some embodiments of the present invention is that it enables users to iteratively refine and define the representations of patterns they are interested, where an abstract can be used at least as a starting point. In some embodiments, it is useful to permit the user to adjust their search using different matching attributes. The search can be performed, for example, by giving higher weights to the matching shape or texture (or color or any other suitable attribute) of the query patch. The weight transformation is learned during the model training process and simply acts as a post-processing functional map of the embedding space. This aspect of the invention can be better appreciated from FIG. 12, where the search starts with a query patch 1200 and search image patches 1205, both provided to step 1210, embedding extraction from the representation learning backbone. The representation learning backbone refers to the representation extraction model used in the final inference pipeline. In an embodiment, the backbone is trained with a nonlinear multilayer perceptron (MLP) head attached to the backbone model. The head is typically discarded after training.

The output e is provided to a holistic match step 1215 as well as shape-based transform 1220 and texture-based transform 1225. The transforms 1220 and 1225 can, in an embodiment, be simple functional mapping and can be either a linear transformation (W*X) or a nonlinear transformation (W2*Relu (W1*X)) that takes in the original embedding e_in and outputs a refined embedding e_out such that values corresponding to specific attributes A are amplified. When the distances between e_out for multiple images are computed, the similarity along the chosen attribute A automatically gets higher weight.

The embedding extracted from the representation learning backbone can be matched to the embeddings in the database either in Euclidean space holistically (i.e., dot product) or in a transformed metric space in which the vectors are more correlated towards specific attributes like shape or texture as illustrated in FIG. 12. For example, the shape-attribute-based matching returns results that preserve the shape of the query object more strictly while being invariant to other attributes. To that end, the model learns the functional maps F_{A} for each attribute A during the training that transforms the embedding vector appropriately. The user will see more appropriate results based on their choice of matching criteria.

An embodiment of the training algorithm for learning the mapping to amplify certain attributes during the search is as follows: (a) for each attribute, pre-process as an input a batch of images to amplify that attribute and downweight other attributes. For example, for shape, edge maps of the input images are created and appearance information is removed in the images; (b) the pre-processed mini-batch is fed through the same teacher student networks but with an appended MLP (Multi-Layer Perceptron) head (separate for each attribute). This MLP head models the functional map F_{A}; (c) the training process minimizes the distance between the transformed embeddings F_{A} (e), in addition to minimizing the distance between the original embeddings e for the teacher and the student network. This amounts to adding a loss term to the combined loss function discussed in the previous section.

Some embodiments of the framework of the present invention can be used not only to search for an example patch but also to assist the user to refine and define a concrete example of the object that he/she is looking for. FIG. 13 shows the iterative flow of how a user can use the framework to first define an abstract and then progressively refine the query to get better matches. By maintaining an ANN (Approximate Nearest Neighbor) based database for embeddings extracted on a large set of geospatial images, searching that database provides fast retrieval of embeddings in the vicinity of the query embedding. A query 1300 is supplied by the user, such that a nearest neighbor search is performed on database 1305, resulting in one or more extracted thumbnails being displayed to the user as search results at 1310. At 1315 the user identifies one or more of the results as closer to the object of interest, whereupon a refined query is created at 1320. The refined query is actualized and returned to query step 1300.

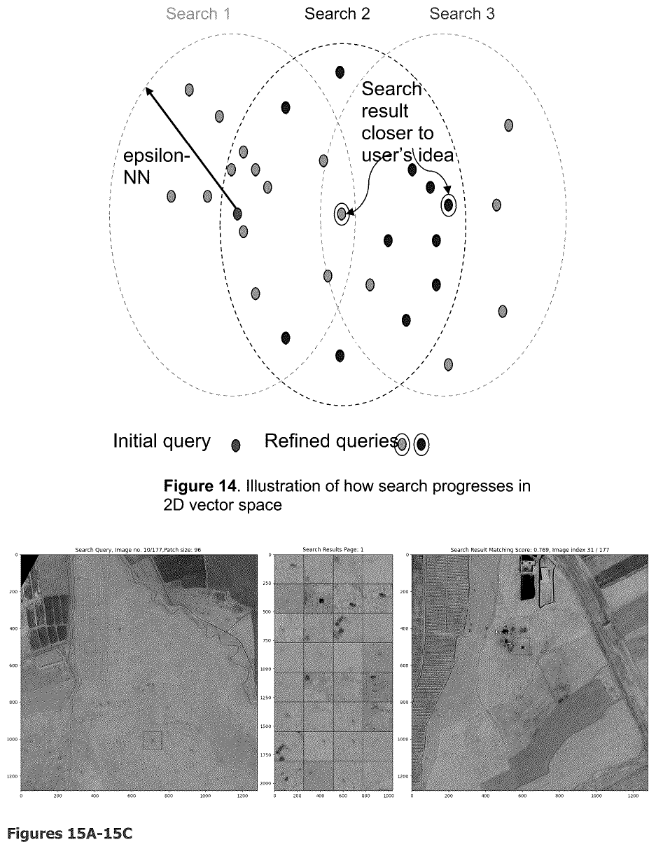

FIG. 14 shows algorithmically how the query refinement works in a two-dimensional embedding search space. Specifically, a user may select an initial query (shown as red circle) and retrieve a set of search results (shown as green circles in Search 1). While the original query is only remotely representative of the example the user is interested in, a possible search result in Search 1 appears to be closer to the abstract pattern that the user is interested in. The user creates a refined query based on that result and runs multiple such searches, such as Search 2 and Search 3 in FIG. 14, to identify a concrete example of what he/she is actually looking for. By refining the query, the last search typically gives the most relevant result, such as the purple of Search 3 in FIG. 14.

FIGS. 15A-15C provide an example of a user refining a query based on the prototype built. FIG. 15A, left image, shows the image where a user selects a query patch, FIG. 15B, middle image, shows the resulting thumbnails, and FIG. 15C, right image, shows the image corresponding to the selected thumbnail. For example, assume the user is searching for solar panels in an image and selects a patch based on their notion of how a dark-colored object appears on the ground. The query is run, after which the user selects the most relevant search results based on their notion of what a solar panel should look like in the image, and creates a refined query by selecting the region around the most relevant search result.

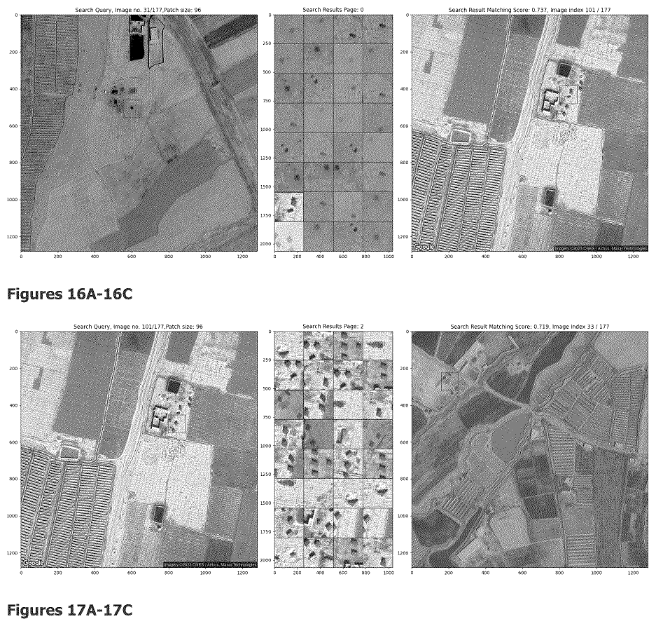

Searching the refined query (by centering the object in the patch) generates more accurate results as shown in FIGS. 16A-16C. The user finds a small solar panel in one of the search results as shown in the middle column below. The corresponding image is shown on the right. With reference to FIGS. 17A-17C, the user further refines the query by selecting the solar panel on the results image. This further creates an improved query. Note that search results are embeddings computed on grid locations and may not contain the object in the center. The refined query patch is therefore better as it contains the object in the center of the selected region. The refined query returns more accurate results of the solar panels in a variety of configurations as shown in FIGS. 17A-17C.

In some embodiments, to achieve an effective search the query preferably entails a specialized searching algorithm, an example of which can be configured as follows: (1) the search results based on the current query are rated for a) diversity b) novelty. Only diverse results are shown to the user while repetitive results are filtered out. (2) Diversity is rated against current query embedding, novelty is rated against user history of queries. (3) Users can specialize search based on the matching attributes (e.g. shape, texture). (4) Search results are sorted based on the combined score to enable the users to perform exploratory search. Such an approach can be used to gather more images containing examples of the object. As shown in FIGS. 17A-17C, the refined query of the solar panels retrieves more diverse results from other images.

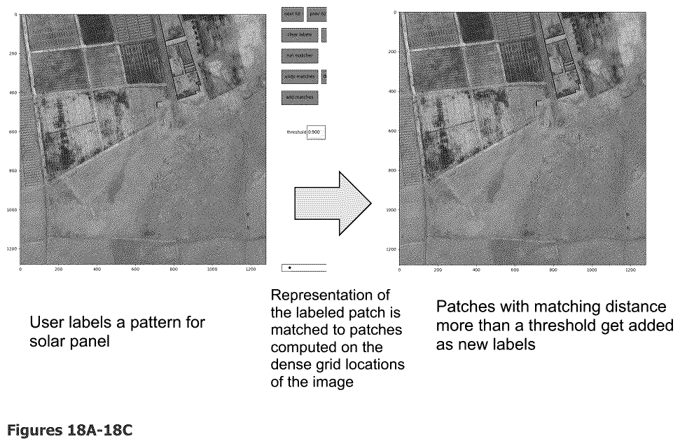

In an embodiment, the framework of the present invention can be used to assist the users to label repetitive structures expeditiously using the labeling tool. FIGS. 18A-18C illustrate the process of such an auto-labeling tool. The patch labeled by the user gets added to a list of representative examples of an object to be labeled. The representation (embedding) computed for the label is matched to the fixed size patches computed on dense grid locations on the same image. The matching confidences greater than a predetermined similarity threshold are outputted as new auto-labels. The bounding box sizes of the labels are obtained from the label sizes of the closest embedding match. In some embodiments, expedited labeling of images involves the following adjustments to the algorithm: (1) the labeling tool needs to be aware of the scale range of the object being labeled. For satellite imagery, the scale does not vary significantly and hence can be specified using an example. (2) when an image is loaded, the embeddings are computed on a dense grid with spacing adjusted according to the scale of the object. In a preferred arrangement of this feature, a threshold is specified by the user to only output the matches that have similarity scores more than that. This can be dynamically adjusted by the user as shown in FIGS. 18A-18C.

If the object of interest is expected to be persistently present at a particular location, then the accuracy of the search can be improved by exploiting temporal consistency of the embedding distances. Let a given query patch Q have embedding e. Consider the following notation:
P(d|match): The probability distribution of embedding distances d from e given that a patch has the same scene content as Q.
P(d|false): The probability distribution of embedding distances d from e given that a patch has the same scene content as Q.

These two probability distributions can be estimated empirically. Given a temporal sequence of n observations of the same location on the ground, we can calculate the probability that the location has the same scene content as Q as follows.

Let the embedding distances of each observation to e be d₁ . . . dₙ. Using Bayes rule, the probability that the location has the same scene content as Q is given by:

$$P ( match \vert {d}_{1} … {d}_{n} ) = \frac{P ( {d}_{1} … {d}_{n} \vert match ) P ( match )}{\begin{matrix}P ( {d}_{1} … {d}_{n} \vert match ) P ( match ) + \\ P ( {d}_{1} … {d}_{n} \vert false ) ( 1 - P ( match ) )\end{matrix}}$$

where P(match) is the prior probability that the same content as Q appears anywhere in the scene at random. This quantity can be estimated empirically or known a priori. For illustration purposes, we can consider it to be equally likely whether it appears or not at random, leading to P(match)=(1−P(match))=0.5. Therefore we obtain:

$$P ( match \vert {d}_{1} … {d}_{n} ) = \frac{1}{1 + \frac{P ( {d}_{1} … {d}_{n} \vert false )}{P ( {d}_{1} … {d}_{n} \vert match )}}$$

If the location has the same scene content as Q then d₁ . . . dₙ will be very small, leading to the ratio

$$\frac{P ( {d}_{1} … {d}_{n} \vert false )}{P ( {d}_{1} … {d}_{n} \vert match )}$$

being extremely small, and falling rapidly to zero with each new observation, leading to the right hand side of the above equation rising quickly to 1, indicating that it is highly certain that the location on the ground has the same scene content as Q.

In some embodiments described herein, plural instances may implement components, operations, or structures described as a single instance and vice versa. Likewise, individual operations of one or more embodiments may be illustrated and described collectively, one or more of the individual operations may be performed concurrently, and the operations may be performed in an order different than that illustrated. Structures and functionality presented as separate components in example configurations may be implemented as a combined structure or single component. Similarly, structures and functionalities presented as separate components may be implemented as a single component. These and other variations, modifications, additions, and improvements fall within the scope of the subject matter herein.

Embodiments described herein as including components, modules, or mechanisms may comprise either software modules (e.g., code embodied on a machine-readable medium or in a transmission signal) or hardware modules. A hardware module comprises a tangible unit configured or arranged to perform the requisite operations. In example embodiments, one or more computer systems (e.g., a standalone, client or server computer system, co-located or remote from one another) or one or more hardware modules of a computer system (e.g., a CPU, a GPU, a processor or a group of processors) may be configured either by software (e.g., an application or application portion) or as a hardware module that operates to perform certain operations as described herein.

In various embodiments, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within one or more general-purpose processors or other programmable processors) that is temporarily configured by software to perform certain operations. It will be appreciated that the implementation of a hardware module in a particular configuration may be driven by cost and time considerations.

Embodiments in which one or more hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Embodiments in which one or more hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).) The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are to be understood merely as convenient labels associated with appropriate physical quantities.

Unless specifically stated otherwise, terms such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The phrase “in an embodiment” used in various places in the specification do not necessarily all refer to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In an embodiment, the invention comprises a self-supervised method for detecting objects of interest in geospatial imagery comprising the steps of providing a dataset representative of a plurality of both natural and man-made objects such as would appear in geospatial images, training a teacher-student model with at least some of the dataset, providing an abstract of an object of interest, the abstract comprising one or more invariant features of the object of interest but insufficient to fully characterize the object of interest, and automating search patterns in the dataset that actualize the abstract to cause the model to return images responsive to the abstract. In a further aspect of at least some embodiments, a method of the invention can comprise the step of providing a dataset comprising in part a data curation step comprising extracting patches of fixed size around detected objects and ensuring that the objects are centered within the associated patch. In still further aspects of some embodiments of the methods of the invention, one or more of the following may be implemented: each object is associated with a class and the object class is preserved; the patches are rotated around the associated centers; the training step comprises algorithmic enhancements for extracting embeddings of at least some of the objects; extracting embeddings comprises the use of metric learning; the training step further comprises gathering objectness attributes from examples of generic objects, the training comprises gathering objectness attributes from examples of generic objects; an objectness score is associated with each detected object; the training comprises post-processing steps to train a stage-1 representation model from labeled data sources, then uses the stage-1 model to extract vector representations of the patches from unlabeled data sources, cluster the vector representations using a clustering algorithm, and order the clusters by decreasing cluster size. In an embodiment the clustering algorithm can be any of a group comprising affinity propagation, mean shift, ward hierarchical clustering, agglomerative clustering, and DBSCAN. In some embodiments, training can comprise training on pretext tasks, and in some embodiment may further include generating one or more positive image pairs by perturbing a single instance of an image. In some embodiments, training may comprise self-distillation wherein a teacher model and a student model have the same architecture and are trained in tandem.

In an embodiment, the invention comprises a system for detecting objects of interest in geospatial imagery comprising: in a processor and associated data storage, providing a dataset representative of a plurality of both natural and man-made objects such as would appear in geospatial images, in the processor, training a teacher-student model with at least some of the dataset, by means of a user interface, providing an abstract of an object of interest, the abstract comprising one or more invariant features of the object of interest but insufficient to fully characterize the object of interest, and in the processor and associated data storage, automating search patterns in the dataset that actualize the abstract to cause the model to return images responsive to the abstract.

In a still further embodiment, the invention comprises one or more computer-readable non-transitory storage media embodying software that is operable when executed to: provide a dataset representative of a plurality of both natural and man-made objects such as would appear in geospatial images, train a teacher-student model with at least some of the dataset, provide an abstract of an object of interest, the abstract comprising one or more invariant features of the object of interest but insufficient to fully characterize the object of interest, and automate search patterns in the dataset that actualize the abstract to cause the model to return images responsive to the abstract.

From the foregoing, it will be appreciated that a new and novel system and method has been disclosed for performing searches in satellite imagery where the initial query is an abstract and the search is able to be refined to yield an example as a result using a self-supervised student teacher platform enhanced to efficiently and effectively search satellite or other geospatial images that present challenges not found with terrestrial images. It is to be understood that, given the teachings herein, those skilled in the art will understand that numerous alternatives and equivalents exist which do not depart from the invention. It will therefore be understood that the present invention and its various aspects and embodiments are to be limited only by the issued claims as supported by the foregoing teachings.

We claim:

1. A self-supervised method for detecting objects of interest in geospatial imagery comprising the steps
providing a dataset representative of a plurality of both natural and man-made objects such as would appear in geospatial images,
training a teacher-student model with at least some of the dataset,
providing an abstract of an object of interest, the abstract comprising one or more invariant features of the object of interest but insufficient to fully characterize the object of interest, and
automating search patterns in the dataset that actualize the abstract to cause the model to return images responsive to the abstract.

2. The method of claim 1 wherein the step of providing a dataset comprises in part a data curation step comprising extracting patches of fixed size around detected objects and ensuring that the objects are centered within the associated patch.

3. The method of claim 2 wherein each object is associated with a class and the object class is preserved.

4. The method of claim 2 wherein the patches are rotated around the associated centers.

5. The method of claim 1 wherein the training step comprises algorithmic enhancements for extracting embeddings of at least some of the objects.

6. The method of claim 5 wherein extracting embeddings comprises the use of metric learning.

7. The method of claim 1 wherein the training step further comprises gathering objectness attributes from examples of generic objects.

8. The method of claim 2 wherein an objectness score is associated with each detected object.

9. The method of claim 1 wherein the training step comprises post-processing steps to train a stage-1 representation model from labeled data sources, use the stage-1 model to extract vector representations of the patches from unlabeled data sources, cluster the vector representations using a clustering algorithm, and order the clusters by decreasing cluster size.

10. The method of claim 9 wherein the clustering algorithm comprises any of a group comprising affinity propagation, mean shift, ward hierarchical clustering, agglomerative clustering, and DBSCAN.

11. The method of claim 1 wherein the training step comprises training on pretext tasks.

12. The method of claim 11 wherein training on pretext tasks comprises generating one or more positive image pairs by perturbing a single instance of an image.

13. The method of claim 1 wherein the training step comprises self-distillation wherein a teacher model and a student model have the same architecture and are trained in tandem.

14. The method of claim 1 wherein the training step comprises one of a group comprising prediction of masked image token representations, direct minimization of contrastive loss using gradient-based methods, contrastive loss minimization using cluster assignment, and non-parametric classification.

15. A system for detecting objects of interest in geospatial imagery comprising
in a processor and associated data storage, providing a dataset representative of a plurality of both natural and man-made objects such as would appear in geospatial images,
in the processor, training a teacher-student model with at least some of the dataset,
by means of a user interface, providing an abstract of an object of interest, the abstract comprising one or more invariant features of the object of interest but insufficient to fully characterize the object of interest, and
in the processor and associated data storage, automating search patterns in the dataset that actualize the abstract to cause the model to return images responsive to the abstract.

16. One or more computer-readable non-transitory storage media embodying software that is operable when executed to:
provide a dataset representative of a plurality of both natural and man-made objects such as would appear in geospatial images,
train a teacher-student model with at least some of the dataset,
provide an abstract of an object of interest, the abstract comprising one or more invariant features of the object of interest but insufficient to fully characterize the object of interest, and
automate search patterns in the dataset that actualize the abstract to cause the model to return images responsive to the abstract.

17. The storage media of claim 16 wherein the software is further operable when executed to perform data curation comprising extracting patches of fixed size around detected objects, ensuring that the objects are centered within associated patches, and, in at least some instances, rotating the associated patches around the respective centers.

18. The storage media of claim 16 wherein an objectness score is associated with each detected object.

19. The storage media of claim 16 wherein the software is further operable when executed to extract vector representations of the patches from unlabeled data sources, to cluster the vector representations, and to order the clusters according to size.

20. The storage media of claim 16 wherein the software is further operable when executed to cause the training step to perform self-distillation wherein a teach model and a student model have the same architecture and are trained in tandem.
